(19) United States
(12) Patent Application Publication
(10) Pub. No.: US 2012/0156656 A1
(43) Pub. Date: Jun. 21, 2012

(54) SYSTEM FOR ASSISTING A SIGHT IMPAIRED INDIVIDUAL

(76) Inventor: Robert Dale Caslick, Bellevue Hill (AU)

(21) Appl. No.: 13/394,312

(22) PCT Filed: Sep. 3, 2010
(86) PCT No.: PCT/AU10/01140

§ 371 Date: Mar. 8, 2012

(30) Foreign Application Priority Data
Sep. 4, 2009 (AU) 2009904299
Mar. 26, 2010 (AU) 210201227

(51) Int. Cl. G09B 21/00

(52) U.S. Cl. 434/113

(57) ABSTRACT

A system (10) for assisting a sight impaired individual to attain information, the system including a pattern (15) of one or more elements (20), the one or more elements (20) being configured to emit electromagnetic radiation, wherein the individual senses an aspect of the electromagnetic radiation and attains the information in accordance with the pattern (15) and the sensed aspect.

### FIELD OF THE INVENTION

The present invention relates to a system for assisting a sight impaired individual and according to one particular example, the system and method described herein can assist a blind individual to attain information such as by reading or the like.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Presently, people without sufficient vision to read using sight have the option to read through touch by using the Braille System. Braille was devised in 1821 by Louis Braille, a blind Frenchman. According to one example, each Braille character or cell is made up of six dot positions, arranged in a rectangle containing two columns of three dots each. A dot may be raised at any of the six positions to form sixty-four permutations, including the arrangement in which no dots are raised. In yet another example of a Braille system, eight dots are provided for use with Braille embossers and refreshable Braille displays. In the 8-dot Braille system, the additional dots are added at the bottom of the cell, giving a matrix 4 dots high by 2 dots wide.

The present invention seeks to substantially overcome, or at least ameliorate, one or more disadvantages of existing arrangements, or provide alternatives to existing arrangements.

### SUMMARY OF THE PRESENT INVENTION

According to one broad form, there is provided herein a system for assisting a sight impaired individual to attain information, the system including a pattern of one or more elements, the one or more elements being configured to emit electromagnetic radiation, wherein the individual senses an aspect of the electromagnetic radiation and attains the information in accordance with the pattern and the sensed aspect.

In one example, the pattern is any one or a combination of Braille, and Alphanumeric characters.

In yet a further example, the one or more elements are one or more light emitting diodes (LEDs).

According to another example, the sensed aspect is any one or a combination of heat, and, light.

In a further example, the attained information allows for the individual to read.

In another example, the pattern of LEDs is provided on a panel, where the colour of the panel contrasts with the colour of the LEDs.

According to another aspect, the panel is wall mounted.

In yet a further form, the pattern of LEDs include the use of any one or a combination of:
a) a raised LED from the panel;
b) a lowered LED within the panel;
c) a missing LED;
d) LEDs of varying colours;
e) an LED turned on; and,
f) an LED turned off.

In another example, the LEDs have a 3 mm diameter and a length of 4 mm.

It will be appreciated that the broad forms, examples, and/or aspects of the invention may be used individually or in combination.

### BRIEF DESCRIPTION OF THE DRAWINGS

An example of the present invention will now be described with reference to the accompanying drawings, in which:—

FIG. 1 is a schematic diagram of an example of a system for assisting a sight impaired individual;

FIG. 2 is a schematic diagram and table of an example of the Braille system standards;

FIG. 3 is a schematic diagram of an example component of the system of FIG. 1 for use with the Braille system;

FIG. 4A is another schematic diagram of an example of the system of FIG. 1;

FIG. 4B is a schematic diagram of an example of an LED which can be used with the system of FIG. 4A;

FIGS. 5A and 5B are schematic diagram of an example of the system of FIG. 1, showing various sizes of panels;

FIG. 5C is a schematic diagram of an example panel and LED spacing; and,

FIG. 6 is a schematic diagram of the example system of FIG. 1, being used by an individual.

### MODES FOR CARRYING OUT THE INVENTION

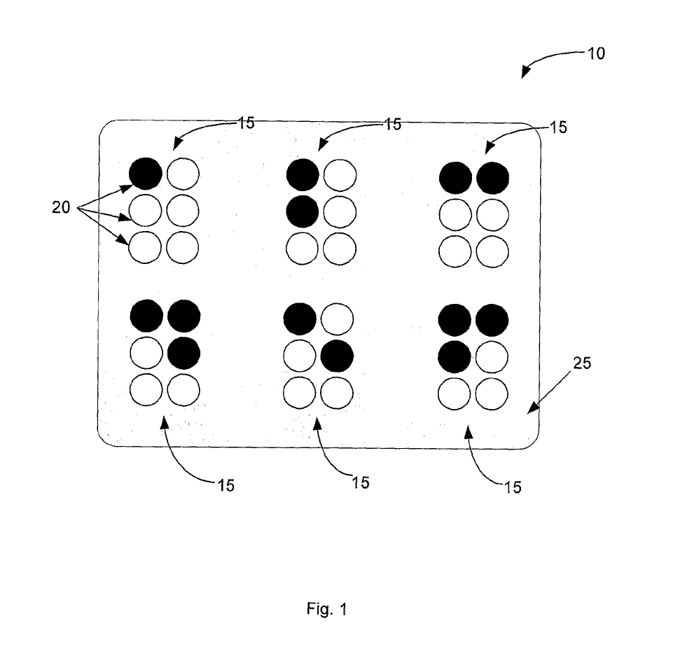

FIG. 1 shows an example of a system for assisting a sight impaired individual, and in this particular information, for assisting a sight impaired individual to attain information.

In this particular example, the system 10 includes one or more patterns 15 of one or more elements 20. The elements 20 are configured to emit electromagnetic radiation. Thus, the individual (not shown in FIG. 1) can sense an aspect of the electromagnetic radiation and attains the information in accordance with the pattern 15 and the sensed aspect of the elements 20.

The pattern 15 can be any one or a combination Braille or the alphanumeric characters themselves, which can then be used to convey information to the user. Thus, in the example shown in FIG. 1 the elements 20 are light emitting diodes (LEDs), which can emit electromagnetic radiation. The aspect of the electromagnetic radiation which can be sensed by an individual in this example is the light emitted from the LEDs. This aspect, together with the pattern can allow for the individual to attain certain information, for example the user of the system can read what is written with the pattern. Notably, it will be appreciated that the heat emitted by LEDs are limited or negligible, which can be particularly advantageous if a user of the system is touching the LED as they are less likely to get burnt or hurt themselves.

FIG. 1 also shows that the pattern 15 of LEDs 20 can be provided on a panel 25, where the colour of the panel 25 is in contrast with the colour of the LEDs 20, thus making it easier for a user to sense an aspect of the electromagnetic radiation of the LED 20.

The colour difference between the panel 25 and the LEDs 20 can further be accentuated by the various patterns 15. For example, in use of the Braille system the pattern can include a series of raised and non-raised dots. The LEDs 20 can thus be arranged such that they are raised from the panel 25, lowered on or within the panel 25, missing from the panel 25, provided in varying colours, turned off, and/or turn on to thereby formulate the pattern of Braille.

Thus, the presently described system can allow for LEDs to be implemented in the Braille system, which can allow a blind person to see/read Braille with their eyes and/or by using their fingertips.

This is due to the discovery that a high percentage of people who are blind are able to see light or distinguish between the absence and presence of light. It will be appreciated, however, that the present system is not limited to electromagnetic radiation emitted from LEDs, and any other form of electromagnetic radiation generation can be used.

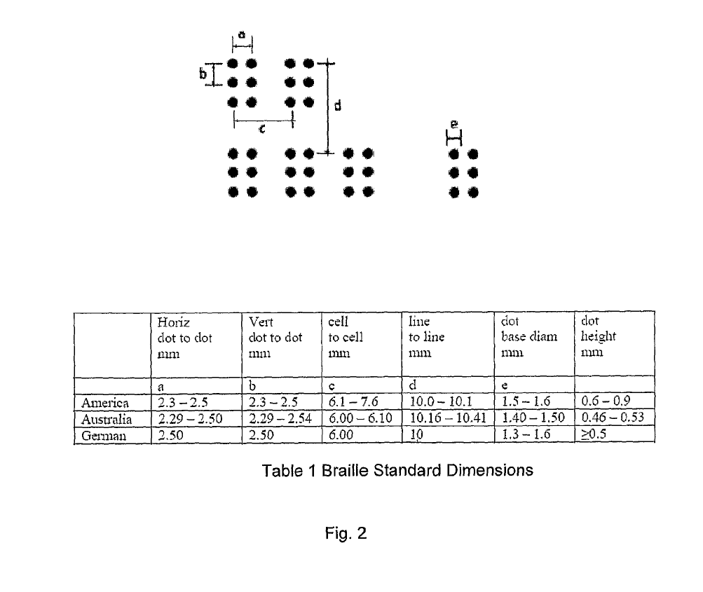

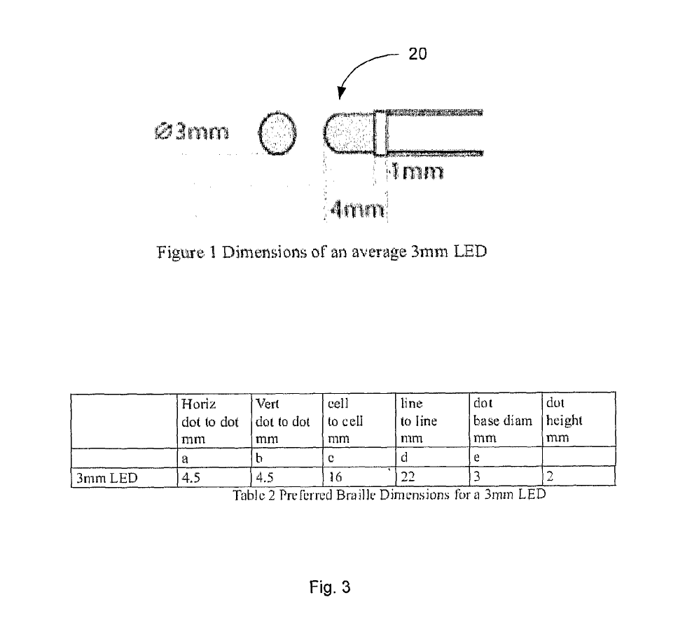

Furthermore, as described herein, according to one example, the pattern formed by the LEDs is a Braille pattern. An example of various Braille dimensions for different countries is shown in FIG. 2. Accordingly, an example of Braille dimensions which can be implemented by 3 mm LEDs is shown in FIG. 3. Notably other sizes of LEDs which are available (for example 1.8 mm LEDs can also be used).

Thus, according to this example, the size of the LED's is not important. However, particular attention is drawn towards the dimensions in which the LED's are arranged. For example, a 3 mm LED light 20 (as shown in FIG. 3) has a diameter of 3 mm and a length of 4 mm and thus is too large to conform to the exact Australian Standard of Braille. However, providing that a scale of the Braille standard dimensions is applied (as shown in FIG. 2), the LED pattern can still be read both with sight and with touch.

Thus, in this example, when implementing the Braille system, Braille dots are substituted with Light Emitting Diodes (LEDs), and where there is no raised dot, there is no LED. The system can allow for the opportunity for a blind person with light perception to see the individual dots (LED's) of the Braille and recognise the associated character. Furthermore, as the LED's are small and produce no (or neglible) heat, it may also be possible for blind people with no light perception to read the tops of the LED's using touch.

As described herein, the system can be achieved using LED's of any colour. However, it is preferable to use contrasting colours when choosing the colour of the LED and mounting surface (which is also referred to herein as a panel). The LED's are mounted preferably on a non-reflective surface to reduce the light from bouncing off the surface and interfering with light produced from other LED's. According to one particular example, the LEDs are sunk into the mount so that only the tops of the LED's protrude out of the surface.

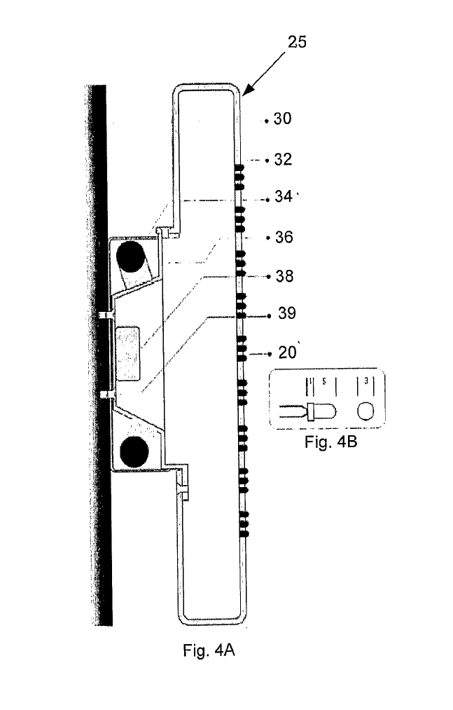

FIG. 4A shows an example of LEDS 20 mounted onto a panel 25, which is then subsequently mounted onto a wall 30. In this particular example, the LEDs 20 used are white 10′000 mcd (mega candelas), an example of which is shown in FIG. 4B. FIG. 4A shows an example of a panel 25 construction, where the panel 25 is formed of an acrylic black cover 32, acrylic translucent legs 34 for mounting to the wall 30, a steel base construction 36, energy/transformers 38, and fixation screws 39.

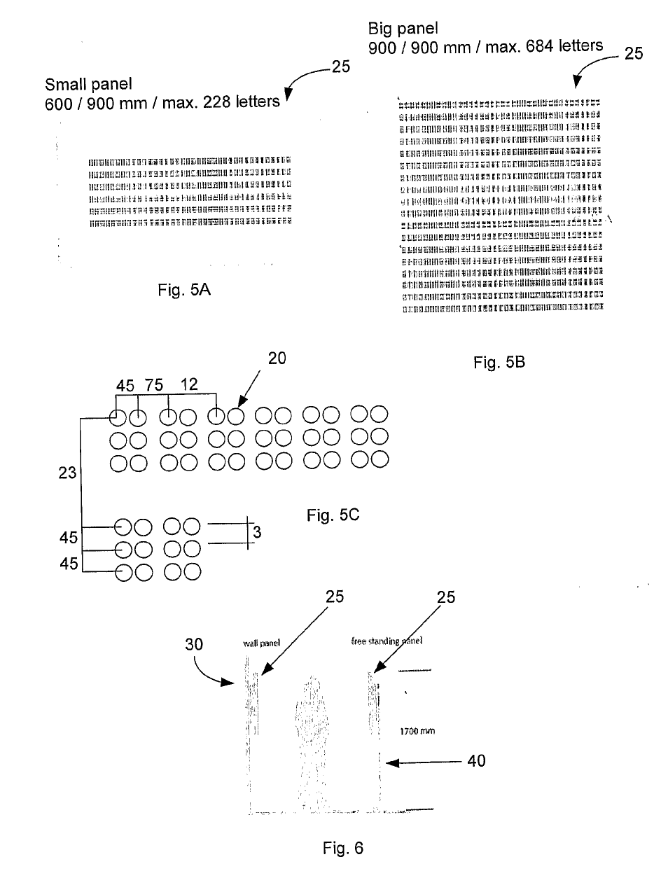

FIGS. 5A and 5B shows the various sizes of panels 25 which can be provided. Thus, for example, FIG. 5A shows an example of a small panel which is 600 mm×900 mm, and can provide a maximum of 228 letters. FIG. 5B is ₐ bigger panel which is 900 mm×900 mm, and can include 684 letters. FIG. 5C shows an example of the spacing of LEDs 20 in mm.

As described herein, a panel 25 can be mounted either onto a wall 30, or can include or be attached to a stand 40, or the like, as shown in FIG. 6. FIG. 6 shows an example of a user reading a wall-mounted panel and a free standing panel.

Accordingly, it will be appreciated that by using LEDs as Braille, this can provide up to 90% of blind people in the world the opportunity to read Braille using sight.

It will be appreciated that many modifications will be apparent to those skilled in the art without departing from the scope of the present invention.

1. An information display for a sight impaired individual, the display including elements arranged in a fixed Braille or alphanumeric pattern corresponding to a piece of information, the elements being tactile to allow the sight impaired individual to interpret the information provided by the fixed Braille or alphanumeric pattern by touch, wherein the elements are configured to emit light for assisting the sight impaired individual to locate the elements.

2. The information display as claimed in claim 1, wherein the elements are arranged on or within a panel.

3. The information display as claimed in claim 2, wherein the colour of the panel contrasts with the colour of the light elements.

4. The information display as claimed in claim 2, wherein the panel is surface mountable.

5. The information display as claimed in claim 2, wherein the elements are elevated from the panel.

6. The information display as claimed in claim 2, wherein the elements are depressions within the panel.

7. The information display as claimed in claim 1, wherein the diameter of each element is about 3 mm.

8. The information display as claimed in claim 1, wherein the diameter of each element is about 1.5 mm.

9. The information display as claimed in claim 1, wherein the diameter of each element is about 1 mm.

10. The information display as claimed in claim 1, wherein the elements are transparent.

11. The information display as claimed in claim 10, further including a light source positioned such that light is emitted from the elements.

12. The information display as claimed in claim 11, wherein the light source includes at least one light emitting diode (LED).

13. The information display as claimed in claim 1, wherein the element is an LED.

14. (canceled)
